(19) United States
(12) Patent Application Publication
(10) Pub. No.: US 2021/0334859 A1
(43) Pub. Date: Oct. 28, 2021

(54) HEADLESS TRANSFORMATION ENGINE FOR CONTENT MANAGEMENT SYSTEMS

(71) Applicant: Pacific By Northwest MFG LLC, Portland, OR (US)

(72) Inventor: Marc Ammann, Portland, OR (US)

(73) Assignee: Pacific By Northwest MFG LLC, Portland, OR (US)

(21) Appl. No.: 17/238,035

(22) Filed: Apr. 22, 2021

Related U.S. Application Data
(60) Provisional application No. 63/013,791, filed on Apr. 22, 2020.

(51) Int. Cl. G06Q 30/02; H04L 29/06

(52) U.S. Cl. CPC G06Q 30/0277; H04L 67/40; G06Q 30/0251

(57) ABSTRACT

A SaaS solution for use with CMS or other marketing systems for creating campaign experiences on modern web technologies is presented herein. The invention allows users to continue to manage campaign content from their existing platforms. Embodiments of the present invention translate and aggregate multiple services into a single layer that is similar in structure to a headless CMS system. The present invention also provides extendibility so that other layers such as commerce or personalization layers may be included.

### CROSS REFERENCE TO RELATED APPLICATION

This application claims benefit of U.S. Provisional Application No. 63/013,791 filed Apr. 22, 2020, the entire disclosure of which is hereby incorporated herein by reference for all purposes.

### FIELD OF THE INVENTION

This disclosure generally relates to the creation of online campaign experiences, and more specifically, to the aggregation or transformation of data used in modern web technologies while still being able to manage content from existing marketing platforms.

### BACKGROUND OF THE INVENTION

One type of system that allows business to manage and retain their electronic content data is a content management system. Content management systems (CMSs) have been developed that allow many users to efficiently share electronic content such as text, audio files, video files, pictures, graphics, etc. Content management systems typically control access to content in a repository. An author (or user) may generate content, and when the content is checked into the repository, the content may be available for reuse by other users. A user may also check out content from the repository, or link to content in the repository while generating content.

Content management systems organize and facilitate the collaborative creation of documents and other content. Electronic content data can be created, secured, retained, destroyed, and monitored when using content management systems. Content management systems (CMSs) typically use a database as the repository for retaining the electronic content data managed by the system.

CMSs with a front-end, a website or view layer, are known as regular or coupled CMSs while those that have had the front-end removed are referred to as headless CMSs. A headless CMS typically comes with an interface to add content and an API to deliver content where needed. These are the two traditional forms of CMSs. What is not presented in the prior art is a system for managing content similar to a headless CMS while allowing for extendibility to include additional data layers such as commerce and personalization layers.

### BRIEF SUMMARY OF THE INVENTION

The present invention is a usage-based Software as a service (SaaS) solution for use with CMS or other marketing systems for creating campaign experiences on modern web technologies. The invention allows users to continue to manage campaign content from the existing platform. Embodiments of the present invention translate and aggregate multiple services into a single layer. The layer into which information is collected and aggregated is similar in structure to a headless CMS system. The present invention also provides extendibility so that other layers such as commerce or personalization layers may be included.

The present invention includes a novel translation engine that translates multiple distinct sources and services into a single GraphQL layer. GraphQL is a software language used to obtain information from databases by client-side applications. GraphQL also allows programmers to create an API that controls how data is presented to a client and is commonly used to integrate multiple existing systems behind a single, concise API. As put another way, GraphQL is a query language for an API and a server-side runtime for executing queries. It does not rely on a specific type of database or storage engine for proper operation, but instead is backed up by the backup engines of existing platforms.

A further understanding of the present invention can be obtained by reference to a preferred embodiment set forth in the accompanying Description. Although the illustrated embodiments are merely exemplary of apparatus or methods for carrying out the present invention, both the organization and method of operation of the invention, in general, together with further objectives and advantages thereof, may be more easily understood by reference to the illustrations and the following Description. The Figures are not intended to limit the scope of this invention, but merely to clarify and exemplify the invention.

### BRIEF DESCRIPTION OF THE DRAWINGS

FIG. 1 is a block diagram showing the integration of the present invention between existing content and websites where campaigns are to be displayed.

### DETAILED DESCRIPTION OF THE INVENTION

In the following detailed Description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed Description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following Description of the preferred embodiment is merely exemplary in nature and is in no way intended to limit the invention, its application, or use.

There has thus been broadly outlined the more important features of the invention in order that the detailed Description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

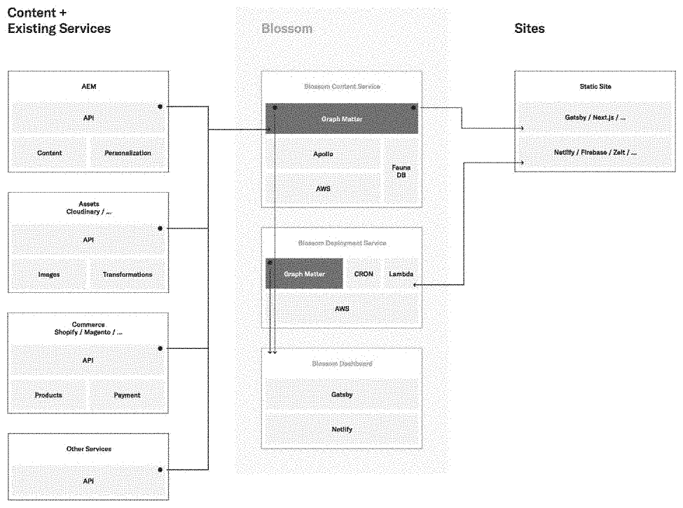

Referring now to FIG. 1, there is shown a block diagram of the present invention and its integration between existing content and websites where campaigns are to be deployed. For purposes of this invention, the term campaign includes, but is not limited to, online marketing campaigns. The present invention is a usage-based SaaS computer-implemented method comprising instructions that cause changes within a computer system. For purposes of this disclosure, the term computer-implemented method and invention can be used interchangeably.

Embodiments of the present invention integrate with existing CMS marketing systems and translates and aggregates data in a single layer for the creation of online campaign experiences that are deployed to static interne sites. These embodiments further include extendibility to include additional layers in the online campaigns such as commerce or personalization layers.

The present invention is designed so that users can manage content of the newly created online campaigns from existing marketing platforms. Embodiments do not rely on a specific technology to constitute its front end, nor to constitute its backend, the content source.

Aggregation and translation of data into a single layer is performed by a foundational element of the invention, a set of machine instructions that translate information from multiple distinct sources and services into a single GraphQL layer. The present invention is designed manage content and create marketing campaigns from content authoring, content preview, and content deployment.

the present invention comprises three distinct, logical parts. There is a content service, a deployment service, and a dashboard.

The content service is the translation layer between marketing system (AEM, Sitecore etc.) and static site experiences. The content service is responsible for structuring source content into a form that can be used by static site generators. The content services is designed to create a paradigm of Sites+Pages and collections of pages are managed as sites. Large marketing systems usually treat an entire website as one site, where every page is part of the website. The present invention allows users to select a small subset of pages from the website to be used as part of the campaign that is being created. Embodiments of the present invention manage the collection of pages that are selected from the larger website structure and allows static sites, sites that are part of the campaign, to access that collection of pages.

Generation of static sites used in the campaign occurs in two ways. One way is constructing embodiments of the present invention to fetch a single page from a CMS and create a corresponding page in the campaign being generated. This can also be referred to as a 1:1 mapping process. The created page will request a specific page identifier during build time. By way of example, the /homepage can create the /page.

A second way of generating static sites used in the campaign occurs by fetching a list of pages that match a specific pattern and create templated pages on the website. By way of example, /products/* would list all the products in the campaign and distinct pages for the listed products could be created in the campaign. In some embodiments, pages could be built for only certain products, or products could be grouped on created pages depending on the requirements of the campaign.

The present invention manages the mapping of source to campaign pages in both the 1:1 mapping method and when fetching lists of pages. This allows the campaign pages to be created during build time

In addition to managing collections of pages as sites, the Sites+Pages paradigm also allows the present invention to manage access to sites and grant external agencies limited access to a small subset of pages. The invention is designed to allow users to grant access to specific sites to external organizations instead of the entire marketing stack. This feature avoids the need for a lengthy and expensive vetting, on-boarding and training process for users of the invention.

Every static site will be provided with a secure token for authentication purposes for use by the site within campaign.

The deployment service manages where static sites are built to. In small organizations, this is usually all managed by the hosting service, like Firebase, Netlify etc. In large, heterogenous environments, this can get unmanageable really quickly. There is no shortage of hosting providers, with Netlify, Zeit and Firebase providing tailored offerings, Gatsby Cloud providing a framework specific offering but also S3 can be used to host static sites. The deployment service abstracts all of these so they can be managed in a single place. The individual configuration is still up to the individual provider, but in order to create automated builds based on content change, users provide input to the invention that instructs the invention when to trigger builds.

The dashboard is a portal that allows users to interface with the invention. In an embodiment of the present invention, the dashboard is constructed to provide users with access to hosting and serverless backend services. The dashboard also allows access to the tools used for static site generation. Content authoring, content preview, and content monitoring can all monitored from the dashboard.

Therefore, the foregoing is considered as illustrative only of the principles of the present invention. Further, since numerous modifications and changes will readily occur to those skilled in the art, it is not desired to limit the present invention to the exact construction and operation described, and accordingly, all suitable modifications and equivalents may be resorted to, falling within the scope of the present invention. While the above Description describes various embodiments, it will be clear that the present invention may be otherwise easily adapted to fit any configuration as desired or required.

As various changes could be made in the above embodiments without departing from the scope of the invention, it is intended that all matter contained in the above Description shall be interpreted as illustrative and not in a limiting sense.

What is claimed is:

1. A method of utilizing a Software as a service (SaaS) with a marketing system for creating campaign experiences on modern web technologies, where the method includes the steps of allowing management of campaign content from a platform; translating and aggregating a plurality of services into a single layer where the single layer is selected from a group consisting of a headless CMS system, a commerce layer, a personalization layer, a system replicating a CMS system, and combinations of these; and providing a translation engine that translates multiple distinct sources and services into a single GraphQL layer; and creating an API capable of presenting data drawn from backup engines of existing platforms.
